(19) United States
(12) Patent Application Publication
(10) Pub. No.: US 2006/0107606 A1
(43) Pub. Date: May 25, 2006

(54) Partition system

(76) Inventor: Matthew D. Remelts, Grand Rapids, MI (US)

Correspondence Address: BRINKS HOFER GILSON & LIONE, P.O. BOX 10395, CHICAGO, IL, 60610, US

(21) Appl. No.: 10/995,050

(22) Filed: Nov. 22, 2004

(51) Int. Cl. E06B 1/04

(52) U.S. Cl. 52/204.1

(57) ABSTRACT

A partition system includes a first and second panel assembly. Each panel assembly includes a frame including a top portion and a bottom portion, and a panel disposed within the frame. A first top connector is disposed at the top portion of the first panel assembly frame. The first top connector includes a first base member disposed within the frame and a first extending member disposed outside of the frame. The first extending member includes a downward facing tab. A second top connector is disposed at the top portion of the second panel assembly frame. The second top connector includes a second base member disposed within the frame and a second extending member disposed outside of the frame. The second extending member includes an upward facing tab.

### BACKGROUND

This invention relates to a partition system for dividing a space.

Systems work spaces have become the common work area in much of the corporate world. Large work areas are divided into smaller work spaces for use by individual workers or small groups of workers. In a dynamic work environment, there is a need for work spaces that can be configured rapidly and easily. Because standard workspace walls are not easily moveable and often require special tools and expertise to set up and take down, moveable panels have developed.

Moveable panels can be used in some types of office environments to provide additional temporary partitioning. These panels allow existing workspaces areas to be subdivided relatively quickly and allow additional privacy to workers. Because it is desirable to have these panels relatively lightweight, past panels have tended to be relatively unstable and prone to tipping over. It is also often difficult to connect the panels to existing conventional workspace walls. Furthermore, the connections between panels are often time-consuming to make, and it is relatively difficult to line up the panels properly.

### SUMMARY

In one aspect, a partition system includes a first and second panel assembly. Each panel assembly includes a frame including a top portion and a bottom portion, and a panel disposed within the frame. A first top connector is disposed at the top portion of the first panel assembly frame. The first top connector includes a first base member disposed within the frame and a first extending member disposed outside of the frame. The first extending member includes a downward facing tab. A second top connector is disposed at the top portion of the second panel assembly frame. The second top connector includes a second base member disposed within the frame and a second extending member disposed outside of the frame. The second extending member includes an upward facing tab. The upward facing tab engages the downward facing tab to secure the first and second panel assembly. A bottom connector is disposed at the bottom portion of the first panel assembly. A second bottom connector is disposed at the bottom portion of the second panel assembly. The first and second bottom connectors secure the first panel assembly to the second panel assembly.

In another aspect, a partition system includes a panel assembly including a frame and a panel disposed within the frame. A top indexing element is disposed at the top portion of the frame. The top indexing element includes a top tab extending from the frame. The top tab is adapted to fit within a vertical opening. A bottom indexing element is disposed at the bottom portion of the frame. The bottom indexing element includes a bottom base member secured to the frame and a bottom tab extending from the frame. The top and bottom tabs are adapted to fit within a vertical opening in a workspace panel.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1A shows an embodiment of a panel assembly.

FIG. 1B shows an exploded view of the components of an embodiment of a panel assembly.

FIG. 2 shows an embodiment of a foot.

FIG. 3 shows an embodiment of a foot attached to a panel assembly.

FIG. 4 shows the end portion of an embodiment of a horizontal frame member.

FIG. 5 shows the top portion of an embodiment of a vertical frame member.

FIG. 6 shows two embodiments of panel assemblies connected in-line.

FIG. 7 shows two embodiments of panel assemblies connected at a 90° angle.

FIG. 8 is an exploded view of embodiments of top connectors.

FIG. 9 is an exploded view of embodiments of bottom connectors.

FIG. 10A shows an embodiment of a top connector disposed in a panel assembly.

FIG. 10B shows an embodiment of another top connector disposed in a panel assembly.

FIG. 10C shows the top connectors and panel assemblies of FIGS. 10A and 10B connected together.

FIG. 11 shows embodiments of bottom connectors connecting two panel assemblies together in an in-line configuration.

FIG. 12 is an exploded view of embodiments of top connectors.

FIG. 13 shows embodiments of top connectors connected together.

FIG. 14 shows embodiments of bottom connectors connecting two panel assemblies together in a 90° configuration.

FIG. 15 shows the insertion of an embodiment of a top connector into a frame.

FIG. 16 is an exploded view of embodiments of bottom connectors.

FIG. 17 shows the connection of an embodiment of a panel assembly with indexing elements to an existing wall panel.

FIG. 18 is an enlarged view of the top indexing element of FIG. 17.

FIG. 19 is an enlarged view of the bottom indexing element of FIG. 17.

FIG. 20 shows an embodiment of a top base member for an indexing element.

FIG. 21 shows an embodiment of a top base member disposed in a panel assembly.

FIG. 22A shows the insertion of an embodiment of a top indexing element into a top base member.

FIG. 22B shows an embodiment of a top indexing element inserted into a top base member.

FIG. 23A shows an embodiment of a top indexing element.

FIG. 23B shows another embodiment of a top indexing element.

FIG. 23C shows another embodiment of a top indexing element.

FIG. 24A shows an embodiment of a 90° indexing element disposed on a panel assembly.

FIG. 24B shows an embodiment of a 120° indexing element disposed on a panel assembly.

FIG. 24C shows an embodiment of an offset 90° indexing element disposed on a panel assembly.

FIG. 25A shows an embodiment of a bottom indexing element.

FIG. 25B shows another embodiment of a bottom indexing element.

FIG. 25C shows another embodiment of a bottom indexing element.

FIG. 26 shows the attachment of an embodiment of a bottom indexing element to a panel assembly.

### DETAILED DESCRIPTION

The invention is described with reference to the drawings. The relationship and functioning of the various elements of this invention are better understood by the following detailed description. However, the embodiments of this invention as described below are by way of example only, and the invention is not limited to the embodiments illustrated in the drawings.

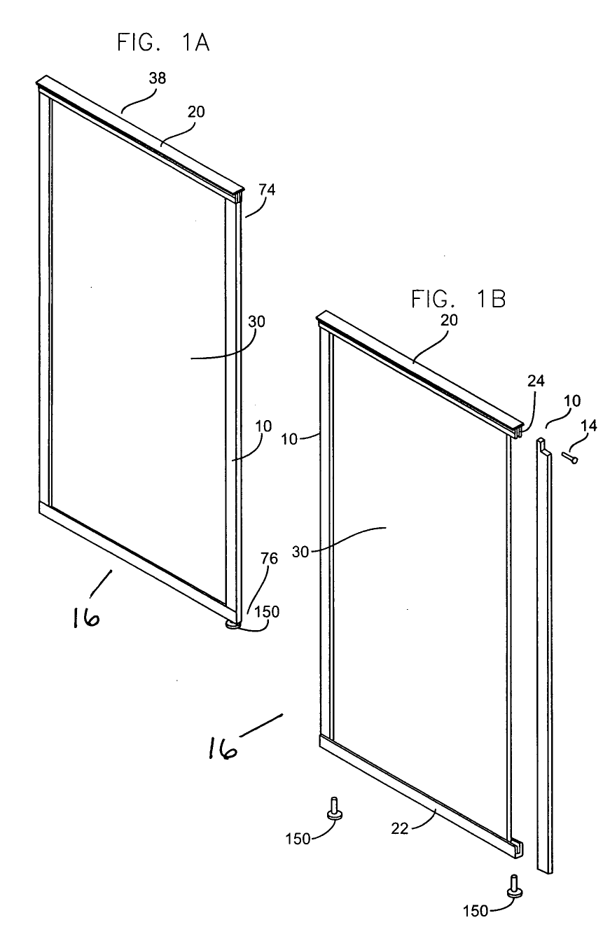

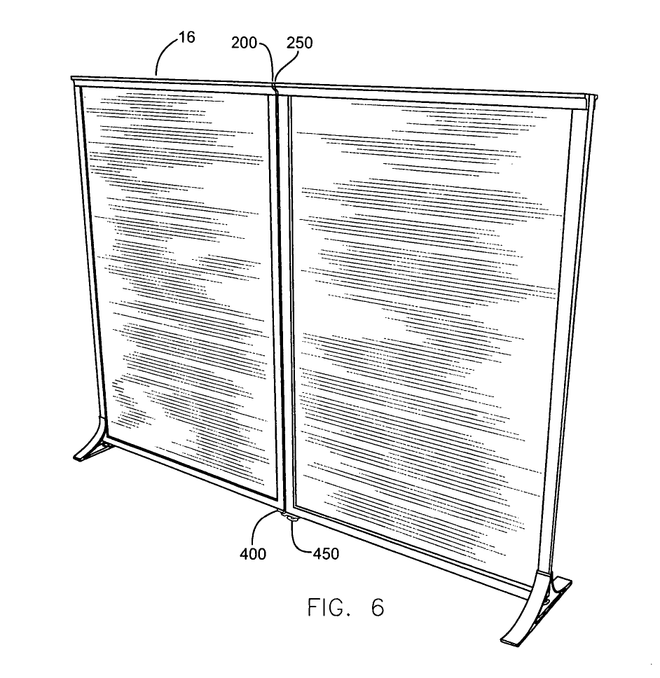

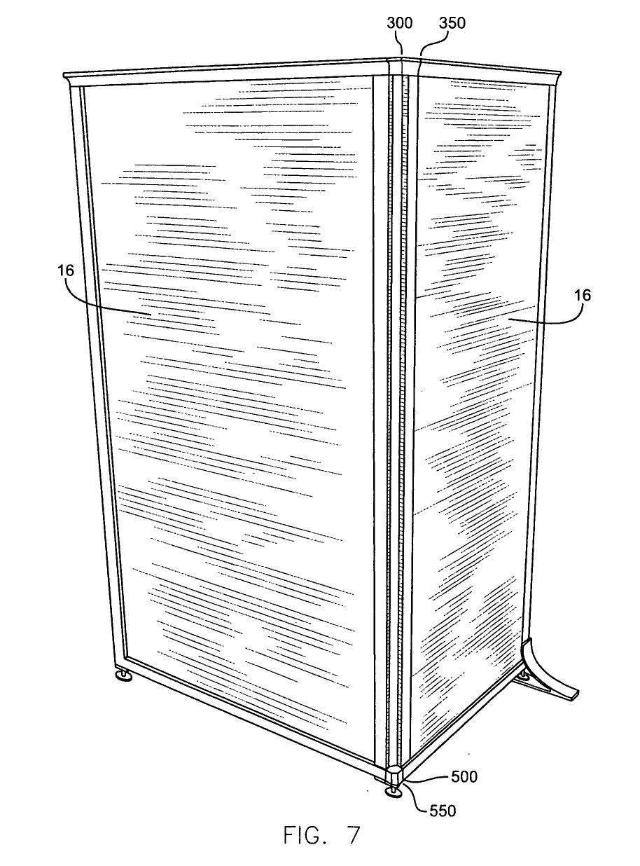

FIGS. 1A and 1B show one embodiment of a panel assembly 16. Panel assemblies 16 are adapted to be connected together by top and bottom connectors. Panel assemblies 16 are also adapted to be connected to existing workspace wall panels by indexing elements. The panel assemblies 16 are connected to one another at their vertical edges to form a partition system. As shown in FIG. 6, in one embodiment, the connections are in-line. In another embodiment, as shown in FIG. 7, the panel assemblies 16 connect to each other at a 90° angle. A variety of configurations of the panel assemblies are thus possible.

Panel assembly 16 includes a frame 38, a top portion 74, and a bottom portion 76. In one embodiment, frame 38 includes two vertical frame members 10, a top horizontal frame member 20, and a bottom horizontal frame member 22. In one embodiment, the frame members are made of aluminum. The frame members include channels adapted to enclose the edge of the panel 30. In one embodiment, the panel 30 is translucent. In another embodiment, the panel 30 is made of plastic. Panel 30 may function as a marker board. Other materials may be used for the frame members and panel depending on the application and desired properties. In one embodiment, the panel assembly 16 is relatively lightweight to allow for easy handling and assembly of a partition system. The frame members 10, 20, and 22 are attached together by any suitable means. In one embodiment, the frame members 10, 20, and 22 are attached together by fasteners 14. In one embodiment, fasteners 14 are screws.

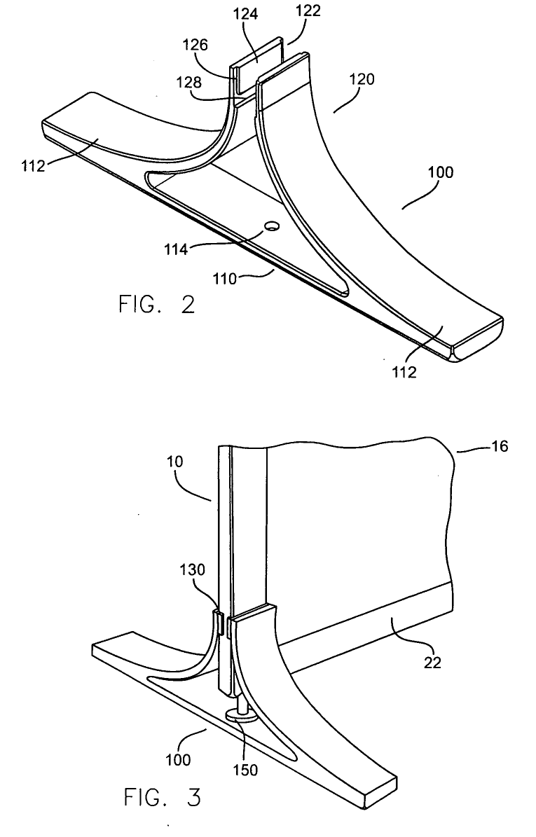

In one embodiment, the bottom portion 76 of the panel assembly is supported by glides 150 as shown in FIGS. 1A and 9. The glide 150 has a disk-shaped bottom 154 with a post 152 to connect to the frame. The panel assembly may also be supported by a foot 100 as shown in FIGS. 2 and 3.

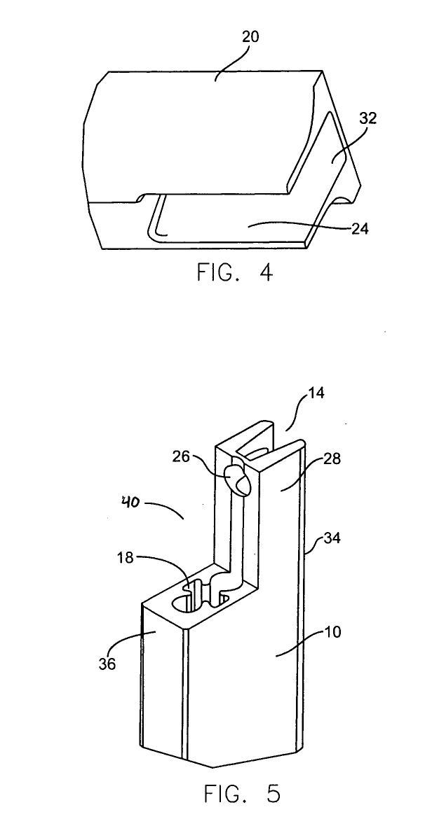

FIG. 4 shows an enlarged view of the end of an embodiment of top frame member 20. Top frame member 20 includes a channel 24 with opening 32. As shown in FIG. 5, the top end of vertical frame member 10 includes a cut-out portion 40. The bottom frame member 22 may also include an opening, as shown in FIG. 1B. Vertical frame member 10 includes an interior edge 34 with a channel 14 and an exterior edge 36. Channel 14 is adapted to hold the edge of panel 30. Vertical frame member 10 also includes a hole 26 and channel 18. When the panel assembly 16 is assembled, the top portion 28 of vertical frame member 10 is disposed in channel 24 in top horizontal frame member 20. The cut out portion 40 and channel 24 define an opening in which a variety of components may be disposed, as described below.

The panel assemblies 16 are connected to one another at their vertical edges to form a partition system. As shown in FIG. 6, in one embodiment, the panel assemblies 16 are connected to each other by a first top connector 200 and first bottom connector 400 disposed on one panel assembly 16 and a complementary second top connector 250 and second bottom connector 450 disposed on a second panel assembly. As shown in FIG. 7, in another embodiment, the panel assemblies 16 connect to each other at a 90° angle by a first top connector 300 and first bottom 550 connector disposed on one panel assembly 16 and a complementary second top connector 350 and second bottom connector 500 disposed on a second panel assembly.

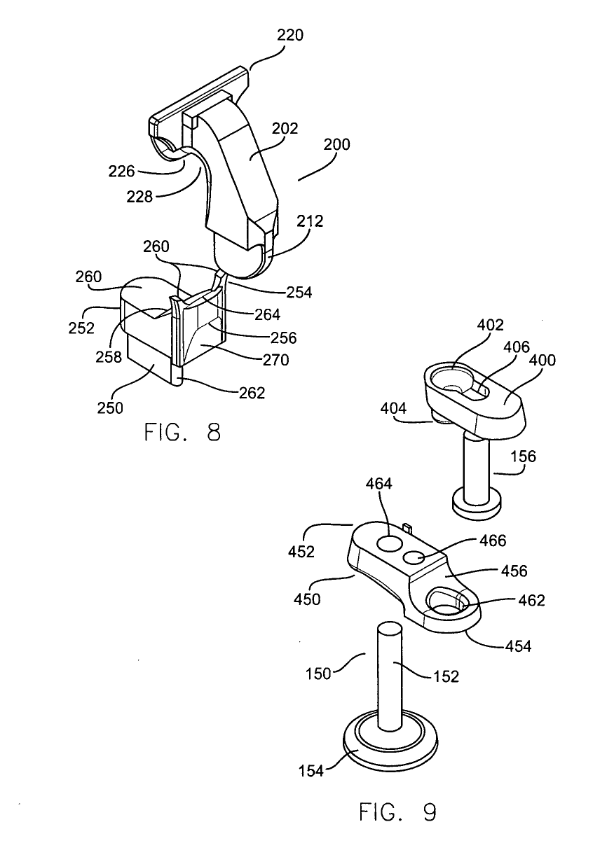

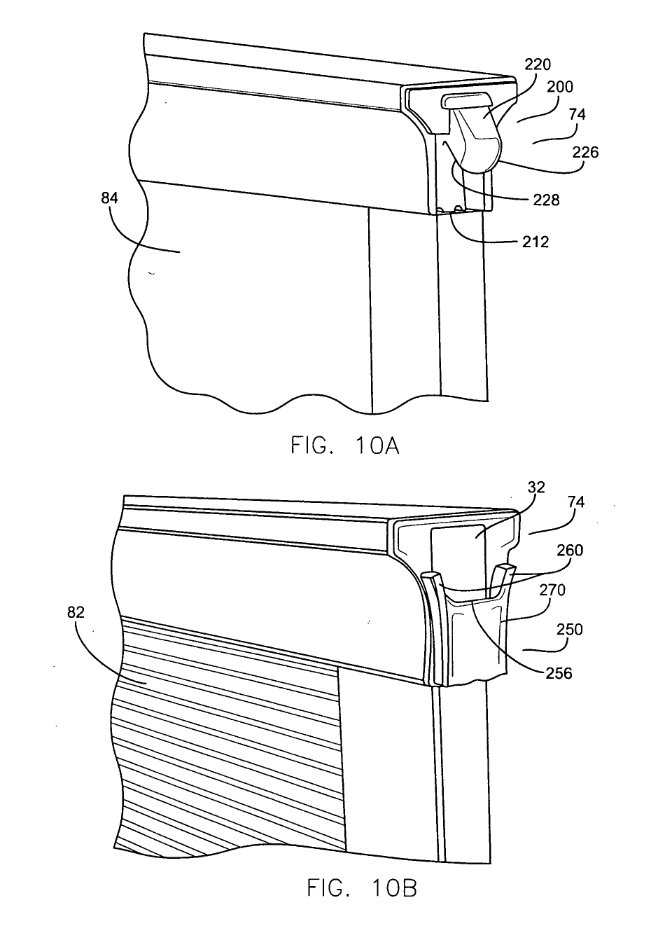

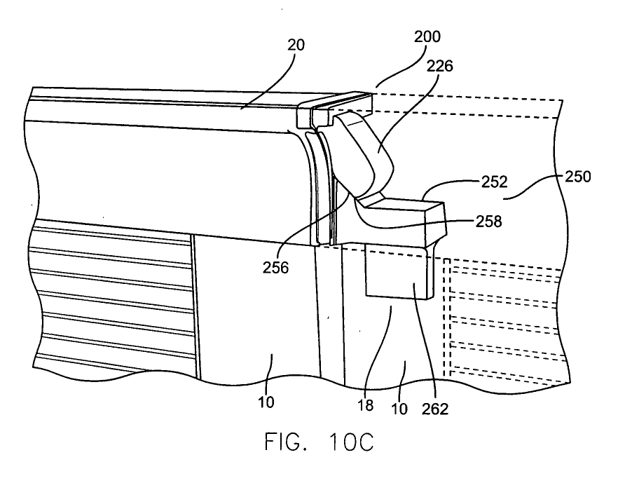

FIG. 8 is an exploded view of embodiments of a first and second top connector for an in-line connection between panel assemblies. A first top connector 200 is adapted to be disposed at the top portion 74 of a panel assembly frame, as shown in FIG. 10A. The top connector includes a base member 202 disposed within the frame and an extending member 220 disposed outside of the frame. The extending member 220 includes a downward facing tab 226 which defines a groove 228. The top connector 200 includes a finger 212 disposed at the bottom of the base member 202. The finger 212 is adapted to be disposed within the channel 18 in vertical frame member 10. In one embodiment, an interference fit holds the base member 202 within the opening in the vertical frame member 10.

A second top connector 250 is adapted to be disposed at the top portion of another panel assembly frame, as shown in FIGS. 8 and 10B. The top connector 250 includes a base member 252 disposed within the frame and an extending member 270 disposed outside of the frame. The extending member 270 includes an upward facing tab 256 which defines a surface 258. In one embodiment, the upward facing tab 256 includes a depression 264 and two upward projecting fingers 260. The top connector 250 includes a downward extending finger 262 disposed at the bottom of the base member 252. The downward extending finger 262 is adapted to be disposed within the channel 18 in vertical frame member 10. In one embodiment, an interference fit holds the base member 252 within the opening in the vertical frame member 10. The extending portions 220 and 270 of top connecting members 200 and 250 have complementary surfaces, as shown in FIG. 10C. The downward extending tab 226 and groove 228 engage the upward facing tab 256 and surface 258.

FIGS. 9 and 11 show embodiments of bottom connectors. A first bottom connector 400 includes a downward facing pin member 404 and an opening 406. In one embodiment, a fastener 156 may be disposed through the opening 406 to secure the bottom connector 400 to the bottom portion 76 of panel assembly 16. The second bottom connector 450 is complementary to the first bottom connector 400 and includes a base portion 452 and an extending portion 454. Extending portion 454 includes an opening or channel 462. The base portion 452 includes an opening 464 for a glide and an opening 466 for a fastener. The upper surface 456 of portion 454 may be curved, with the bottom connector 400 having a complementary curved surface.

As shown in FIG. 11, in one embodiment, when bottom connectors 400 and 450 are attached together, base portion 452 and bottom connector 400 line up at the bottom vertical edges of the panel assemblies 82 and 84, and portion 454 extends from the vertical edge of panel assembly 82 under panel assembly 84. Pin member 404 of the first bottom connector 400 is disposed in the opening or channel 462 of the second bottom connector 450, thus securing the bottom connectors together.

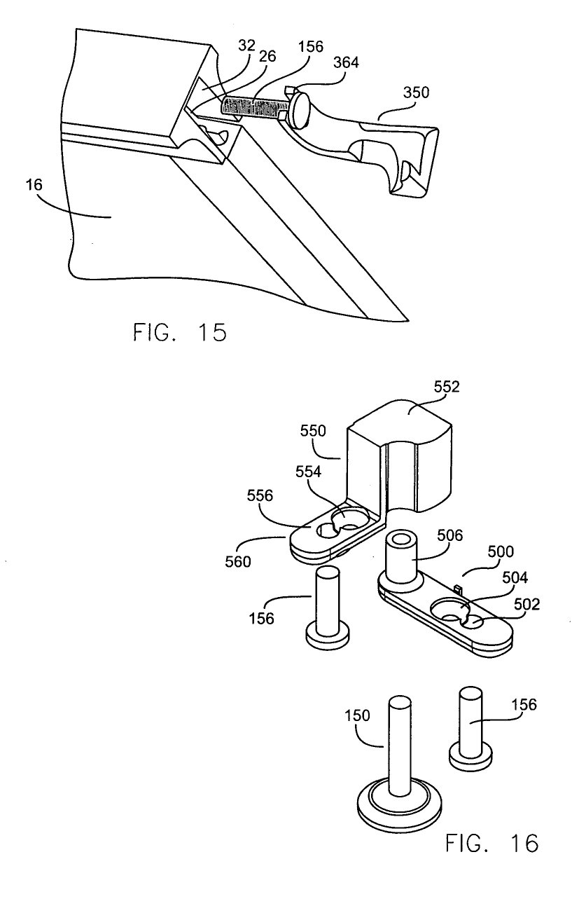

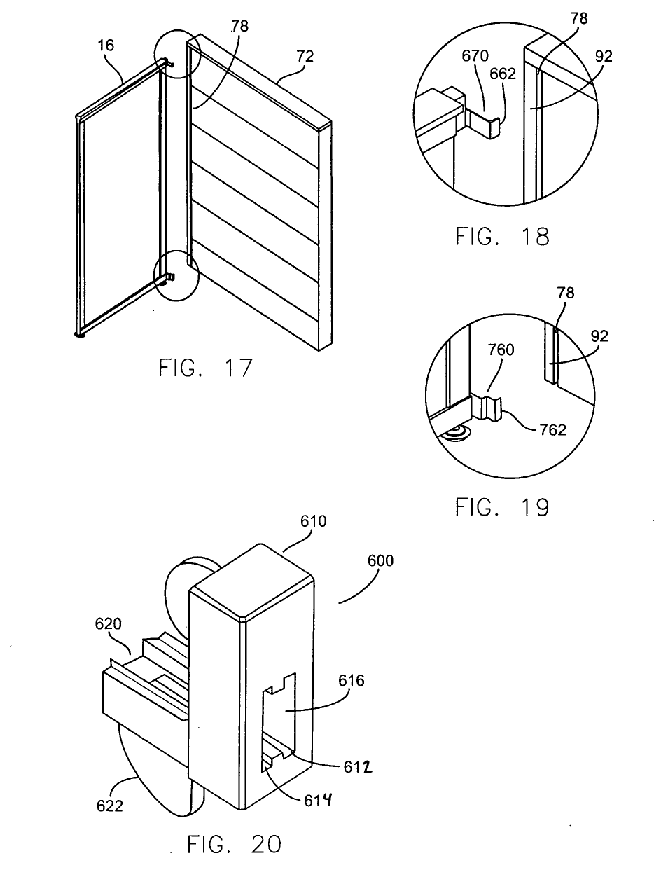

In one embodiment, a method of attaching two panel assemblies includes starting with and building away from either a wall-mounted panel assembly (such as that shown in FIG. 17 and described below) or a freestanding panel assembly, hereinafter referred to as the “fixed panel assembly” 82. A panel assembly that is to be attached to a “fixed panel assembly” is hereinafter called a “free panel assembly” 84.

In one embodiment, the method includes installing the second top connector 250 and the second bottom connector 450 on the fixed panel assembly 82, as shown in FIGS. 10B and 11. The fixed panel assembly 82 may stand in place while the free panel assembly 84 is lifted or tipped to make the connection. A bottom connector 450 is attached to the bottom portion of fixed panel assembly 82. In one embodiment, a fastener is inserted through hole 466 in bottom connector 450, and into the bottom frame member of the fixed panel assembly 82. A glide 150 may be inserted into hole 464 and into panel 82. Top connector 250 is then inserted into opening 32 in top frame member 20 and pushed into place, with finger 262 disposed in channel 18, as shown in FIGS. 10B and 10C.

The first top connector 200 and the first bottom connector 400 are then installed on the free panel assembly 84. In one embodiment, a fastener 156 is inserted through hole 406 in bottom connector 400, and into the bottom of the free panel assembly 84. Top connector 200 is then inserted into a slot into channel 24 in top frame member 20 and pushed into place, with finger 212 being disposed in channel 18, as shown in FIG. 10A.

The pin 404 on bottom connector 400 on the free panel assembly 84 is aligned with opening 462 on the fixed panel assembly 82, and tab 226 of top connector 200 on the free panel assembly 84 is aligned with tab 256 of top connector 250 on the fixed panel assembly 82. Pin 404 is then inserted into opening 462, and downward extending tab 226 and groove 228 of top connector 200 engage the upward facing tab 256 and surface 258 of top connector 250. Both pairs of connectors are thus connected securely, as shown in FIGS. 10C and 11. The panel assemblies may then be leveled by adjusting the glides 150.

The panel assemblies may also be connected at a 90° angle, as previously shown in FIG. 7. For a 90° connection, top connectors 300 and 350 connect the tops of the panel assemblies, and bottom connectors 500 and 550 connect the bottoms of the panel assemblies. FIG. 12 shows an exploded view of embodiments of first and second top connectors 300, 350. A first top connector 300 is adapted to be disposed at the top portion of a first panel assembly frame. The top connector 300 includes a base member 302 adapted to be disposed within the frame and an extending member 320 adapted to be disposed outside of the frame. The extending member 320 includes a groove 322 on its bottom side. Base member 302 includes a downward extending finger 312 which is adapted to be disposed in channel 18 in vertical frame member 10.

A second top connector 350 is adapted to be disposed at the top portion of another panel assembly frame. The top connector 350 includes a base member 352 adapted to be disposed within the frame and an extending member 354 adapted to be disposed outside of the frame. In one embodiment, the extending member 354 includes an upward facing tab 356, a ridge 366, and a curved portion 358. The upper surface of connector 350 complements the lower surface of connector 300. The base member 362 includes an upward directed portion 362 with a cutout 364. The cutout 364 is used to secure the top connector 350 to the frame with a fastener. As shown in FIG. 15, a fastener 156 may be used to attach top connector 350 to panel assembly 16. Fastener 156 is disposed in cutout 364 and is inserted into hole 26 in vertical frame member 10.

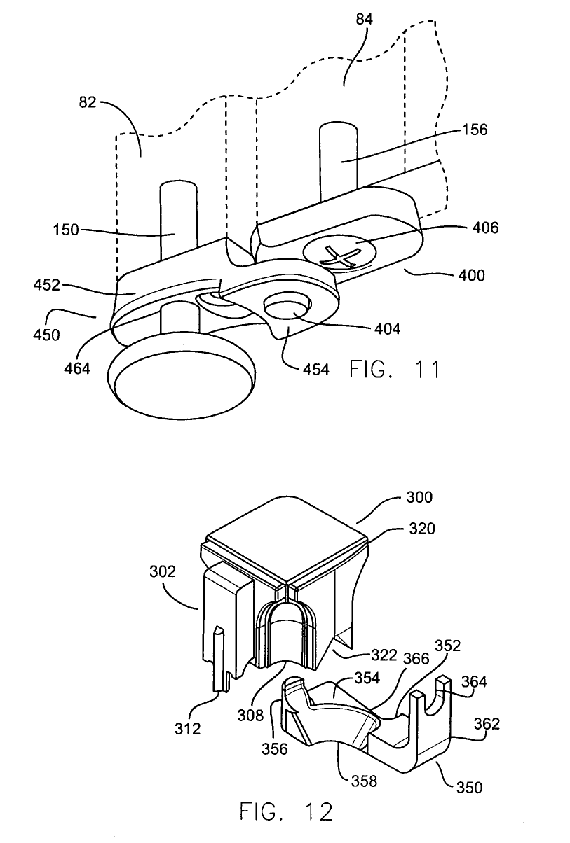

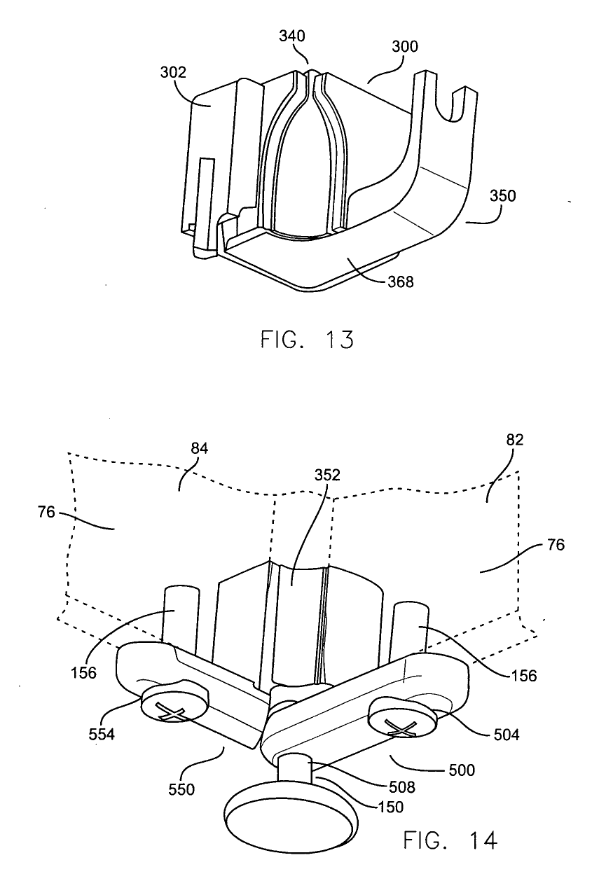

FIG. 13 shows top connectors 300 and 350 connected together. The top surface of connector 350 is complementary to the bottom surface of connector 300, with ridge 366 disposed in groove 322. Connector 350 includes a flat bottom surface 368. In one embodiment, when the top connectors 300 and 350 are assembled, extending members 354 and 320 form a generally cubical structure 340.

FIG. 16 shows an exploded view of embodiments of bottom connectors 500, 550 for connecting panel assemblies at a 90° angle. A first bottom connector 500 includes an upward facing pin member 506. In one embodiment, a fastener 156 is disposed through the opening 504 to secure the bottom connector 500 to a panel assembly 16, as also shown in FIG. 14. A glide 150 may be disposed through hole 508 and into bottom connector 500. The second bottom connector 550 includes a base portion 560 and an extending portion 552. In one embodiment, extending portion 552 has a generally cubical structure of similar appearance to the structure 340 formed by top connectors 300 and 350. The base portion 560 includes an opening 554. The pin member 506 of the first bottom connector 500 is disposed in an opening in the second bottom connector 550 to secure the bottom connectors together. A fastener 156 may disposed through the opening 556 to secure the bottom connector 550 to the panel assembly.

In one embodiment, a method of connecting two panel assemblies at a 90° angle includes installing the top connector 350 and the bottom connector 500 on the fixed panel assembly 82. This allows the fixed panel assembly 82 to stand in place while the free panel assembly 84 is lifted or tipped to make the connection. Top connector 350 is secured to fixed panel assembly 82. In one embodiment, fastener 156 is inserted through cutout or slot 364 in top connector 350, and into a hole 26 in the top frame member 20 of the fixed panel assembly 82, as shown in FIG. 15. Bottom connector 500 is then secured to fixed panel assembly 82. In one embodiment, a fastener is inserted through hole 504 in bottom connector 500, and into the bottom frame member of the fixed panel assembly 82, as shown in FIG. 14. Glide 150 may be inserted into hole 508 in the bottom connector 500.

Top and bottom connectors 300 and 550 are then attached to free panel assembly 84. In one embodiment, a fastener 156 is inserted through hole 554 in bottom connector 550, and into the bottom of the free panel assembly 84. Base member 302 of top connector 300 is inserted into the free panel assembly 84 and pushed into place, with downward extending finger 312 disposed in channel 18 in vertical frame member 10. The bottom connector 550 on the free panel assembly 84 is aligned with pin 506 of bottom connector 500 on the fixed panel assembly 82, and tab 356 and ridge 366 of top connector 300 on the free panel assembly 84 are aligned with groove 322 of top connector 300 on the fixed panel assembly 82. Pin 506 is inserted into the bottom of extending member 552 and ridge 366 is disposed in groove 322. Both pairs of connectors are thus connected securely, shown in FIGS. 7, 13, and 14. The panel assemblies may then be leveled by adjusting the glides 150.

In one embodiment, the vertical edges of the panel assemblies 16 are connected to a conventional workspace wall panel 72 by indexing elements, as shown in FIG. 17. The indexing elements allow the panel assembly to line up in the desired location of the workspace panel. As shown in FIGS. 18 and 19, indexing elements 670 and 760 include tabs 662, 762 that are adapted to extend into a vertical slot 78 in an existing workspace panel 72. In one embodiment, the connection between the panel assembly 16 and the workspace wall panel 72 is made at a 90° angle. In another embodiment, the connection is made at a 120° angle.

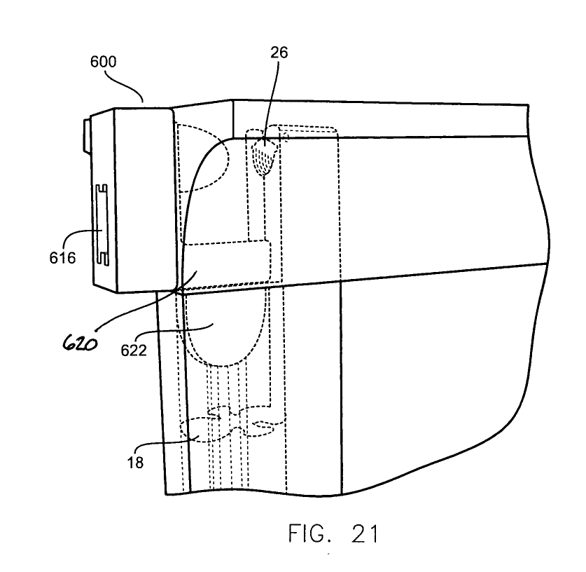

In one embodiment, the top indexing element is disposed in a top base member 600. As shown in FIG. 20, the top base member 600 includes an interior base 620, a downward extending finger 622, and an exterior portion 610. An opening 616 with receiving slots 612 and 614 is provided in the exterior portion 610. Receiving slots 612 and 614 extends horizontally through the top base member 620. FIG. 21 shows a top base member 600 disposed at the top portion of a panel assembly 16. The interior base 620 of top base member 600 is disposed into the top part of a panel assembly. Downward extending finger 622 is disposed in channel 18.

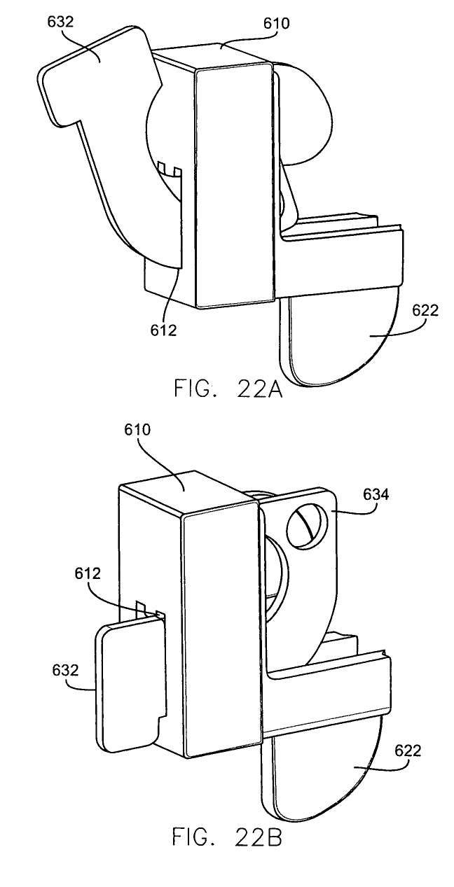

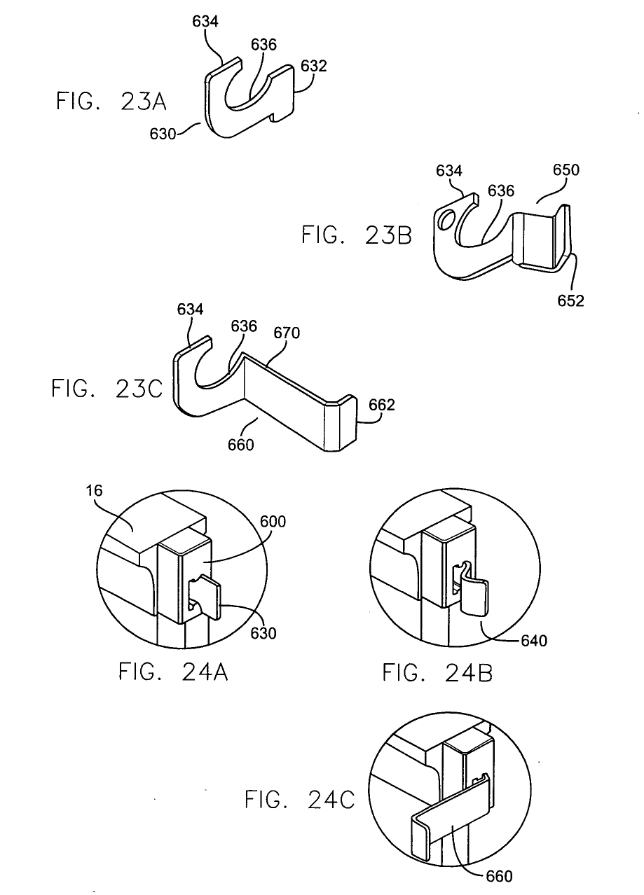

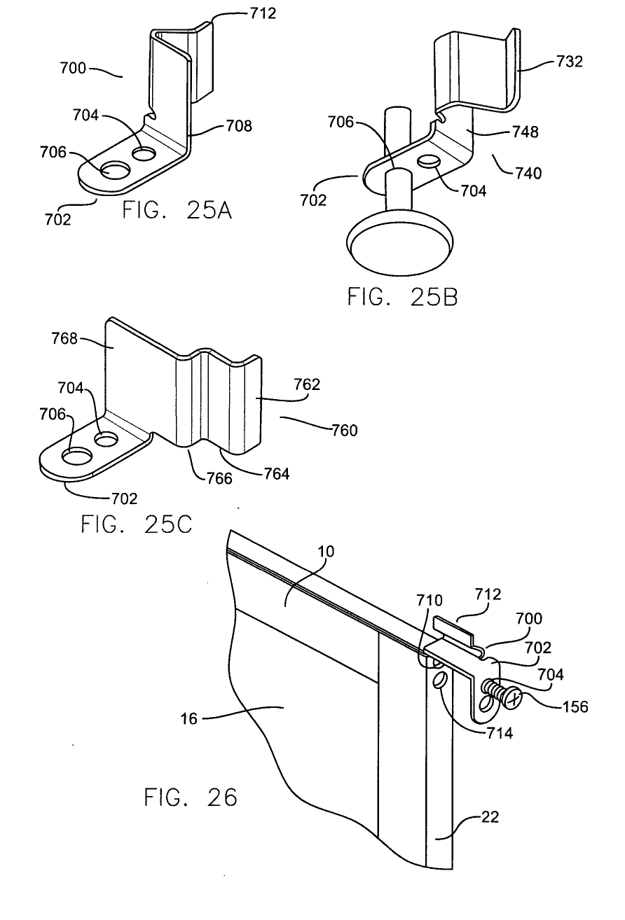

Embodiments of top indexing elements are shown in FIGS. 23A-23C. As shown in FIG. 25A, top indexing element 630 is used for a 90° connection to an existing wall panel. Top indexing element 630 includes a tab 632, hook 634, and arm 636. As shown in FIGS. 22B and 24A, hook 634 and arm 636 are disposed in receiving slot 612.

Similarly, top indexing element 650 is used to dispose a panel assembly 16 at a 120° connection to an existing wall panel. As shown in FIG. 23B, top indexing element 650 includes a tab 652, hook 634, and arm 636. Hook 634 and arm 656 are disposed in receiving slot 612 of top base member 600, as shown in FIG. 24B. A top indexing element that is a mirror image of member 650 can be used for a 120° connection in the opposite direction.

Top indexing element 660 is used to dispose a panel assembly 16 at an offset 90° connection to an existing wall panel. As shown in FIG. 23C, top indexing element 660 includes a tab 662, hook 634, arm 636, and extension 670. In one embodiment, hook 634 and arm 636 are disposed in receiving slot 612 of base member 600, with extension 670 disposed adjacent the vertical edge 92 existing workspace panel 72, as shown in FIGS. 18 and 24C. A top indexing element that is a mirror image of member 660 can be used for an offset 90° connection in the opposite direction.

In one embodiment, the top indexing elements are assembled by inserting interior base 620 of top base member 600 into opening 32 in the panel assembly 16, with downward extending finger 622 disposed in vertical channel 18. Hooking member 634 of top indexing element 630, 650, or 670 is inserted into receiving slot 612, as shown in FIG. 22A. Tab 632 is then rotated downward into place, moving hooking member 634 against the back surface of top base member 600 to secure it into place, as shown in FIG. 22B.

A bottom indexing element attaches to the bottom portion 76 of the panel assembly 16. Various embodiments of bottom indexing elements are elements 700, 740, and 760, as shown in FIGS. 25A, 25B, and 25C. Each bottom indexing element has a horizontal base member 702 with holes 704 and 706. Hole 704 is adapted to receive a fastener to secure the bottom indexing element to a frame. Hole 706 is adapted to receive a glide 150 mounted through the bottom indexing element to the frame.

As shown on FIG. 25A, bottom indexing element 700 provides a 90° connection to an existing wall panel and includes a vertically extending portion 708 and tab 712. Similarly, bottom indexing element 720 provides a 120° connection to an existing wall panel, and includes a vertically extending portion 748 and tab 732. Bottom indexing element 760 is for an offset 90° connection to an existing wall panel, and includes a vertically extending portion 768, portions 766 and 764, and tab 762. Tabs 712, 732, and 762 are adapted to be inserted into a vertical slot 78 in panel 72. Slot 72 may be an opening between two panels, an opening between a panel and a frame, or any other conceivable vertical opening. Bottom indexing elements that are mirror images of bottom indexing elements 720 and 760 may also be used for connections in the opposite direction.

In one embodiment, the bottom indexing elements 700, 740, and 760 are attached to the panel assembly 16 by a connector 156 through hole 704 in base member 702, as shown in FIG. 26. In one embodiment, bottom frame member 22 has holes 710, 714 to facilitate attachment of the base member 702. A glide such as glide 150 may be disposed through hole 706 and into the panel assembly 16. Other modes of attachment are possible and will be apparent to those skilled in the art.

A panel assembly 16 connected to a workspace wall with top and bottom indexing elements such as those shown in FIGS. 17 through 26 may be further connected to a second panel assembly 16 with top and bottom connectors, such as those shown in FIGS. 8 through 16. Thus, in one embodiment, the first end of panel assembly 16 is connected to a conventional workspace wall panel 72 by indexing elements, as shown in FIG. 17. Then, a second panel assembly 16 is connected to the first panel assembly 16 by a first top connector 200 and first bottom connector 400 disposed on the second end of the first panel assembly 16 and a complementary second top connector 250 and second bottom connector 450 disposed on a second panel assembly. It is apparent that further panel assemblies may be connected to the second panel assembly to create a partition system for dividing a workspace, with a variety of configurations possible.

In one embodiment, the bottom portion 76 of the panel assembly is supported by glides 150 as shown in FIGS. 1A and 9. The distance between the bottom 154 of the glide 150 and the bottom portion 76 of the panel assembly may be adjusted to level the panel assembly 16. The panel assembly may also be supported by a foot 100 as shown in FIGS. 2 and 3. In one embodiment, the foot 100 has a top portion 120, a bottom 110, hole 114, and two extending side portions 112. The top portion 120 includes an opening 122, and indents 126 and 128 around portion 124. An opening spacer clip 130 is adapted to be positioned in opening 122 and around the panel assembly 16. Opening spacer clip 130 may have a surface which connects with indents 126 and 128 and portion 124 of foot 100. FIG. 3 shows a foot attached to a panel assembly. A glide 150 may be disposed between the bottom of foot 100 and the bottom frame member 22.

As described herein, fasteners, such as fastener 156, include any sort of mechanical attachment device, including screws, bolts, nails, rivets, and the like.

The embodiments described above and shown herein are illustrative and not restrictive. The scope of the invention is indicated by the claims rather than by the foregoing description and attached drawings. The invention may be embodied in other specific forms without departing from the spirit of the invention. Accordingly, these and any other changes which come within the scope of the claims are intended to be embraced therein.

What is claimed is:

1. A partition system comprising:
a first and second panel assembly, each panel assembly comprising
a frame comprising a top portion and a bottom portion; and
a panel disposed within the frame;
a first top connector disposed at the top portion of the first panel assembly frame, the first top connector comprising
a first base member disposed within the frame; and
a first extending member disposed outside of the frame, the first extending member comprising a downward facing tab;
a second top connector disposed at the top portion of the second panel assembly frame, the second top connector comprising:
a second base member disposed within the frame; and
a second extending member disposed outside of the frame, the second extending member comprising an upward facing tab, wherein the upward facing tab engages the downward facing tab to secure the first and second panel assembly;
a first bottom connector disposed at the bottom portion of the first panel assembly; and
a second bottom connector disposed at the bottom portion of the second panel assembly, wherein the first and second bottom connectors secure the first panel assembly to the second panel assembly.

2. The partition system of claim 1 wherein one of the first bottom connector and the second bottom comprises a pin member and the other of the first bottom connector and the second bottom connector comprises an opening disposed around the pin member.

3. The partition system of claim 1 wherein the first bottom connector comprises a downward facing pin member and a fastener securing the first bottom connector to the first panel assembly.

4. The partition system of claim 1 wherein the first bottom connector comprises a pin member, and the second bottom connector comprises a portion extending generally horizontally from a vertical edge of the second frame and an opening, the opening disposed around the pin member.

5. The partition system of claim 4 wherein the second bottom connector comprises a fastener securing the second bottom connector to the second panel assembly.

6. The partition system of claim 1 wherein the top and bottom connectors connect the first panel assembly to the second panel assembly in a substantially in-line configuration.

7. The partition system of claim 1 wherein the top and bottom connectors connect the first panel assembly to the second panel assembly at an angle of about 90°.

8. The partition system of claim 7 wherein the first extending member comprises a downward-facing channel, and the second extending member comprises a ridge disposed in the downward-facing channel.

9. The partition system of claim 1 wherein the first panel assembly comprises an opening and the first top connector is attached to the panel assembly by an interference fit of the base member with the opening.

10. The partition system of claim 9 wherein the frame comprises first and second vertical frame members, at least one of the vertical frame members comprising a vertical channel, and the first top connector comprises a downward extending finger disposed in the vertical channel.

11. The partition system of claim 1 wherein the second panel assembly comprises an opening and the first top connector is attached to the panel assembly by an interference fit of the base member with the opening.

12. The partition system of claim 11 wherein the frame comprises first and second vertical frame members, at least one of the vertical frame members comprising a vertical channel, and the second top connector comprises a downward extending finger disposed in the vertical channel.

13. A method of assembling a partition system comprising:
providing a first and second panel assembly, each panel assembly comprising a frame comprising a top portion and a bottom portion, wherein a first bottom connector is disposed at the bottom portion of the first frame and a second bottom connector is disposed at the bottom portion of the second frame;
disposing a first top connector at the top portion of the first panel assembly, wherein the first top connector comprises a first base member disposed within the frame and a first extending member disposed outside of the frame, the first extending member comprising a downward facing tab;
disposing a second top connector at the top portion of the second panel assembly, wherein the second top connector comprises a second base member disposed within the frame and a second extending member disposed outside of the frame, the second extending member comprising an upward facing tab; and
engaging the upward facing tab and the downward facing tab, and engaging the first and second bottom connectors, to secure the first panel assembly to the second panel assembly.

14. The method of claim 13 wherein the frame comprises first and second vertical frame members and wherein one of the vertical frame members comprises a vertical channel and the first top connector comprises a downward extending finger, the method comprising disposing the downward extending finger into the vertical channel.

15. The method of claim 14 wherein the frame comprises first and second vertical frame members and wherein one of the vertical frame members comprises a vertical channel and the second top connector comprises a downward extending finger, the method comprising disposing the downward extending finger into the vertical channel.

16. The partition system of claim 13 wherein the first bottom connector comprises a pin member and the second bottom connector comprises an opening, the method comprising disposing the pin member into the opening.

17. A partition system comprising:
a panel assembly comprising a frame comprising a top portion and a bottom portion, and a panel disposed within the frame;
a top indexing element disposed at the top portion of the frame, the top indexing element comprising a top tab extending from the frame, the top tab adapted to fit within a vertical opening in a workspace panel; and
a bottom indexing element disposed at the bottom portion of the frame, the bottom indexing element comprising a bottom base member secured to the frame and a bottom tab extending from the frame, the bottom tab adapted to fit within a vertical opening in a workspace panel.

18. The partition system of claim 17 further comprising a top base member, wherein the frame comprises an opening and the top base member is disposed within the opening, and the top indexing element is secured to the top base member.

19. The partition system of claim 18 wherein the frame comprises a vertical channel and the top base member comprises a horizontal slot and a downward extending finger disposed in the vertical channel.

20. The partition system of claim 19 wherein the top indexing element comprises a curved portion disposed within the horizontal slot.

21. The partition system of claim 19 wherein the top indexing element comprises a hooked portion engaging the top base member to secure the top indexing element within the top base member.

22. The partition system of claim 17 wherein the bottom indexing element comprises a horizontal base portion and a vertically extending portion adjacent the horizontal base portion.

23. The partition system of claim 22 wherein the horizontal base portion comprises an opening and a fastener is disposed in the opening to attach the bottom indexing element to the panel assembly.

24. The partition system of claim 17 wherein the top and bottom tabs are adapted to orient the panel assembly perpendicular to the workspace panel.

25. The partition system of claim 17 wherein the top and bottom tabs are adapted to orient the panel assembly at a 120° angle relative to the workspace panel.

26. A method of assembling a partition system comprising:
providing a panel assembly comprising a frame with a top and bottom portion;
disposing a top base member at the top portion of the panel assembly;
connecting a top indexing element to the top base member, wherein the top indexing element comprises a top tab;
disposing a bottom indexing element at the bottom portion of the panel assembly, the bottom indexing element comprising a bottom base member and a bottom tab; and
disposing the top tab and the bottom tab within a vertical opening in a wall panel.

27. The method of claim 26 wherein the frame comprises an opening, the method further comprising disposing the top base member within the opening.

28. The method of claim 26 wherein the frame comprises a vertical channel; the top base member comprises a horizontal slot and a downward extending finger; and the method further comprises disposing the downward extending finger of the top base member into the vertical channel and disposing the top indexing element within the horizontal slot.

29. The method of claim 28 wherein the top indexing element comprises a curved portion, and wherein disposing the top indexing element within the horizontal slot comprises inserting an end of the top indexing element into the horizontal slot and rotating the tab downward to engage the top indexing element with the base element and secure it thereto.

30. The method of claim 26 wherein the bottom base member comprises a horizontal portion comprising an opening, the method comprising disposing a fastener in the opening to attach the bottom indexing element to the panel assembly.

31. The method of claim 26 further comprising orienting the panel assembly perpendicular to the workspace panels.

32. The method of claim 26 further comprising orienting the panel assembly at a 120° angle relative to the workspace panels.

33. The method of claim 26, wherein the panel assembly comprises a first panel assembly with a first and second end, wherein the top base member is disposed at the top portion of the first end and the bottom base member is disposed at the bottom portion of the first end, the method further comprising:
providing a second panel assembly, the second panel assembly comprising a frame with a top and bottom portion, wherein a first bottom connector is disposed at the bottom portion of the second end of the first panel assembly and a second bottom connector is disposed at the bottom portion of the second panel assembly;
disposing a first top connector at the top portion of the second end of the first panel assembly, wherein the first top connector comprises a first base member disposed within the first panel assembly frame and a first extending member disposed outside of the first panel assembly frame, the first extending member comprising a downward facing tab;
disposing a second top connector at the top portion of the second panel assembly, wherein the second top connector comprises a second base member disposed within the second panel assembly frame and a second extending member disposed outside of the second panel assembly frame, the second extending member comprising an upward facing tab; and
engaging the upward facing tab and the downward facing tab, and engaging the first and second bottom connectors, to secure the first panel assembly to the second panel assembly.
